(19) United States
(12) Patent Application Publication
(10) Pub. No.: US 2022/0260191 A1
(43) Pub. Date: Aug. 18, 2022

(54) DEAD-END SAP LINE CONNECTOR AND SAP COLLECTION SYSTEM COMPRISING SAID DEAD-END SAP LINE CONNECTOR

(71) Applicant: LES ÉQUIPEMENTS LAPIERRE INC., Saint-Ludger (CA)

(72) Inventors: Carl LAPIERRE, Saint-Ludger (CA); Jean-François GOULET, St-Damien de Buckland (CA)

(21) Appl. No.: 17/651,669

(22) Filed: Feb. 18, 2022

Related U.S. Application Data
(60) Provisional application No. 63/200,165, filed on Feb. 18, 2021.

(51) Int. Cl. F16L 41/02; A01G 23/14; F16L 33/30

(52) U.S. Cl. CPC F16L 41/023; F16L 33/30; A01G 23/14

(57) ABSTRACT

A dead-end sap line connector for a sap collection system is provided. The dead-end sap line connector comprises a fluid transfer body having interconnected walls defining a hollow inner chamber being in fluid communication with a plurality of fittings each extending from one of said walls; a first fitting being engageable with the drop line; and a second fitting extending in a direction orthogonal to the first fitting and being engageable with the lateral line. The dead-end sap line connector further comprises a sealing member extending from one of said walls in a direction opposite to said first fitting, and a plugged fitting extending from one of said walls in a direction opposite to said second fitting. A sap collection system comprising said dead-end sap line connector is also provided. Moreover, an alternative dead-end sap line connector (and a system comprising said dead-end sap line connector) is also provided.

### CROSS-REFERENCE TO RELATED APPLICATIONS

This application claims benefit of U.S. patent application Ser. No. 63/200,165, filed on Feb. 18, 2021, which is incorporated herein in its entirety by reference.

### FIELD OF THE INVENTION

The present invention relates to a dead-end sap line connector and sap collection system comprising said dead-end sap line connector.

### BACKGROUND OF THE INVENTION

Sap line connectors (sometimes called a “tee” or “tee fitting”) are used in sap collection systems to connect drop lines to lateral lines. Conventional sap line connectors typically have three fittings extending outwardly from the sap line connector, with two fittings opposing each other and the third fitting being orthogonal to the other two so as to form a “T” shape. The two opposing fittings are connected to tubing forming part of the lateral line, whereas the third fitting is reserved for the drop line.

Dead-end sap line connectors (also called endline sap line connectors) are usually installed at the top of lateral lines (at the end tree) to terminate the sap collection system. With certain dead-end sap line connectors, one of the two opposing fittings is plugged such that no sap can pass through. With such dead-end sap line connectors, either the “right” fitting is plugged, as shown in FIG. 1, or the “left” fitting is plugged, as shown in FIG. 2.

Another kind of dead-end sap line connector, sometimes referred to as a “Y” sap line connector is known, as shown in FIG. 3. In such a connector, two opposing fittings are connected to tubing, one of which is reserved for the lateral line, with the other reserved for the drop line. Such “Y” sap line connectors generally comprise two plugged fittings projecting at a less-than-45-degree angle relative to the fitting reserved for the drop line, thereby giving the connector its “Y” shape. A length of tubing can be wrapped around the back of the maple tree and then connected to the two plugged fittings, thereby creating a harness to support the tension of the lateral line.

Conventional sap line connectors (including dead-end sap line connectors) generally further comprise a projection extending in a direction that is orthogonal to the other fittings. This projection is usually a plug, pin, or cap, which can be used to seal a corresponding tap or spout (or the drop line directly in the case of producers that toss their spouts after the gathering season) connected to a nearby tree. Sap line connectors (including dead-end sap line connectors) are installed such that the projection extends outwardly from the tree (thereby making it more easily accessible). Accordingly, depending on how a dead-end sap line connector is being installed (e.g. whether sap will be flowing to the left, to the right, or directly outward once it reaches the dead-end sap line connector), a different dead-end sap line connector will be used (either a dead-end sap line connector with a plugged “right” fitting, one with a plugged “left” fitting, or the above-defined “Y” shaped connector.

### SUMMARY OF THE INVENTION

In accordance with the present invention, there is provided:
1. A dead-end sap line connector for a sap collection system comprising a drop line, an end tree, end-tree tubing, and a lateral line, wherein the dead-end sap line connector comprises:
   a fluid transfer body having interconnected walls defining a hollow inner chamber being in fluid communication with a plurality of fittings each extending from one of said walls; a first fitting of said plurality of fittings being engageable with the drop line to convey sap from the end tree to said inner chamber; and a second fitting of said plurality of fittings extending in a direction orthogonal to the first fitting and being engageable with the lateral line of the sap collection system to convey sap from said inner chamber to the lateral line;
   a sealing member extending from one of said walls in a direction opposite to said first fitting, said sealing member having a sealing body to seal a corresponding spout or drop line adapted to receive sap from the end tree; and
   a plugged fitting extending from one of said walls in a direction opposite to said second fitting and being engageable with end-tree tubing adapted to secure said dead-end sap line connector to the end tree.
2. The dead-end sap line connector of item 1, wherein at least one of the first fitting, the second fitting, the sealing member, or the plugged fitting is shaped and configured to releasably yet securely engage with 5/16″ tubing or 3/16″ tubing, preferably 5/16″ tubing.
3. The dead-end sap line connector of item 1, wherein the first fitting, the second fitting, the sealing member, and the plugged fitting are each shaped and configured to releasably yet securely engage with 5/16″ tubing or 3/16″ tubing, preferably 5/16″ tubing.
4. The dead-end sap line connector of any one of items 1-3, wherein each of the first fitting, the second fitting, the plugged fitting, and the sealing member comprises barbs.
5. The dead-end sap line connector of any one of items 1-4, wherein the sealing member is a plug, pin, or cap.
6. The dead-end sap line connector of any one of items 1-4, wherein the sealing member is a 3-stage pin configured to seal either a tap or spout or drop line.
7. The dead-end sap line connector of any one of items 1-4, wherein the sealing member is a cap configured to sealingly and releasably receive a tap or spout.
8. The dead-end sap line connector of any one of items 1-7, wherein the sealing member comprises additional sealing members projecting out therefrom.
9. The dead-end sap line connector of item 8, wherein the additional sealing members project out from the sealing member in directions parallel to the second fitting and the plugged fitting.
10. The dead-end sap line connector of any one of items 1-9, wherein the plugged fitting is visually distinct from the second fitting.
11. The dead-end sap line connector of any one of items 1-10, wherein the plugged fitting has a slight protrusion on a distal end thereof.
12. A sap collection system comprising the dead-end sap line connector of any one of items 1-11.
13. The sap collection system of item 12, wherein the sap collection system comprises at least one lateral line, one or more drop lines, a tap or spout for each drop line, end-tree tubing, and an end tree, wherein one or more lateral lines are secured to their corresponding end tree using the dead-end sap line connector as defined in any one of items 1-11.
14. The sap collection system of item 13, wherein the at least one lateral line connects to a main line.
15. The sap collection system of item 14, wherein the main line brings the sap to a releaser and vacuum pump.
16. The sap collection system of any one of items 13-15, wherein the sap collection system comprises multiple lateral lines, wherein each lateral line is secured to its corresponding end tree using the dead-end sap line connector as defined in any one of items 1-11.
17. The sap collection system of any one of items 13-16, wherein the dead-end sap line connector is secured to a corresponding end tree using a line end hook or an end-ring fitting.
18. A dead-end sap line connector fora sap collection system comprising a drop line, an end tree, end-tree tubing, and a lateral line, wherein the dead-end sap line connector comprises:
   a fluid transfer body having interconnected walls defining a hollow inner chamber being in fluid communication with a plurality of sap fittings each extending from one of said walls; a first fitting of said plurality of fittings being engageable with the drop line to convey sap from the end tree to said inner chamber; and a second fitting of said plurality of fittings extending in a direction orthogonal to the first fitting and being engageable with the lateral line of the sap collection system to convey sap from said inner chamber to the lateral line;
   a sealing member extending from one of said walls in a direction opposite to said first fitting, said sealing member having a sealing body to seal a corresponding spout or drop line adapted to receive sap from the end tree; and
   a first plugged fitting and a second plugged fitting, each extending from one of said walls in a direction orthogonal to said first fitting and said second fitting and being engageable with end-tree tubing adapted to secure said dead-end sap line connector to the end tree, said first plugged fitting extending in a direction opposite to said second plugged fitting.
19. A sap collection system comprising the dead-end sap line connector of item 18.

### BRIEF DESCRIPTION OF THE DRAWINGS

FIG. 1 is an isometric view of a conventional left-oriented dead-end sap line connector used in the prior art;

FIG. 2 is a conventional right-oriented dead-end sap line connector used in the prior art;

FIG. 3 is an isometric view of a conventional dead-end sap line connector in a “Y” shape used in the prior art;

FIG. 4 is a front view of a dead-end sap line connector according to an embodiment of the present invention;

FIG. 5 is an isometric right side view of the dead-end sap line connector of FIG. 4;

FIG. 6 is an isometric left side view of the dead-end sap line connector of FIG. 4;

FIG. 7 is a front view of the dead-end sap line connector of FIG. 4, connected to the drop line, and wherein the sealing member thereof is connected to the other end of the drop line;

FIG. 8 is a front view of the dead-end sap line connector of FIG. 4, connected to the drop line wherein the sealing member thereof is connected to a sap collection spout of the drop line;

FIG. 9 is a front view of a dead-end sap line connector according to another embodiment of the present invention;

FIG. 10 is an isometric right side view of the dead-end sap line connector of FIG. 9, wherein the sealing member thereof is connected to a sap collection spout;

FIG. 11 is a front view of the dead-end sap line connector of FIG. 9, connected to the drop line, wherein the sealing member thereof is connected to a sap collection spout of the drop line;

FIG. 12 is a front view of a dead-end sap line connector according to another embodiment of the present invention;

FIG. 13 is a front view of the dead-end sap line connector of FIG. 12, wherein the sealing member thereof is connected to a sap collection spout;

FIG. 14 is a front view of a dead-end sap line connector according to another embodiment of the present invention;

FIG. 15 is an isometric view of a dead-end sap line connector according to another embodiment of the present invention;

FIG. 16 is a front view of the dead-end sap line connector of FIG. 15;

FIG. 17 is a back view of the dead-end sap line connector of FIG. 15;

FIG. 18 is a right side view of the dead-end sap line connector of FIG. 15;

FIG. 19 is a left side view of the dead-end sap line connector of FIG. 15;

FIG. 20 is a top view of the dead-end sap line connector of FIG. 15;

FIG. 21 is a bottom view of the dead-end sap line connector of FIG. 15;

FIG. 22 is an isometric view of a dead-end sap line connector according to another embodiment of the present invention;

FIG. 23 is a front view of the dead-end sap line connector of FIG. 22;

FIG. 24 is a back view of the dead-end sap line connector of FIG. 22;

FIG. 25 is a right side view of the dead-end sap line connector of FIG. 22;

FIG. 26 is a left side view of the dead-end sap line connector of FIG. 22;

FIG. 27 is a top view of the dead-end sap line connector of FIG. 22;

FIG. 28 is a bottom view of the dead-end sap line connector of FIG. 22;

FIG. 29 shows a sap collection system comprising the dead-end sap line connector of FIG. 4 with a spout inserted into a tree;

FIG. 30 shows the sap collection system of FIG. 29 with the spout plugged with the sealing member of the dead-end sap line connector;

FIG. 31 is an isometric view of an alternative dead-end sap line connector according to an alternative embodiment of the present invention;

FIG. 32 is an isometric view of a dead-end sap line connector according to another alternative embodiment of the present invention;

FIG. 33 is a front view of the dead-end sap line connector of FIG. 32;

FIG. 34 is a back view of the dead-end sap line connector of FIG. 32;

FIG. 35 is a right side view of the dead-end sap line connector of FIG. 32;

FIG. 36 is a left side view of the dead-end sap line connector of FIG. 32;

FIG. 37 is a top view of the dead-end sap line connector of FIG. 32;

FIG. 38 is a bottom view of the dead-end sap line connector of FIG. 32;

FIG. 39 is an isometric view of a dead-end sap line connector according to another alternative embodiment of the present invention;

FIG. 40 is a front view of the dead-end sap line connector of FIG. 39;

FIG. 41 is a back view of the dead-end sap line connector of FIG. 39;

FIG. 42 is a right side view of the dead-end sap line connector of FIG. 39;

FIG. 43 is a left side view of the dead-end sap line connector of FIG. 39;

FIG. 44 is a top view of the dead-end sap line connector of FIG. 39;

FIG. 45 is a bottom view of the dead-end sap line connector of FIG. 39;

FIG. 46 shows a sap collection system comprising the dead-end sap line connector of FIG. 31 with a spout inserted into a tree;

FIG. 47 shows the sap collection system of FIG. 46 with the spout plugged with the sealing member of the dead-end sap line connector.

### DETAILED DESCRIPTION OF THE ILLUSTRATIVE EMBODIMENTS

Dead-End Sap Line Connector

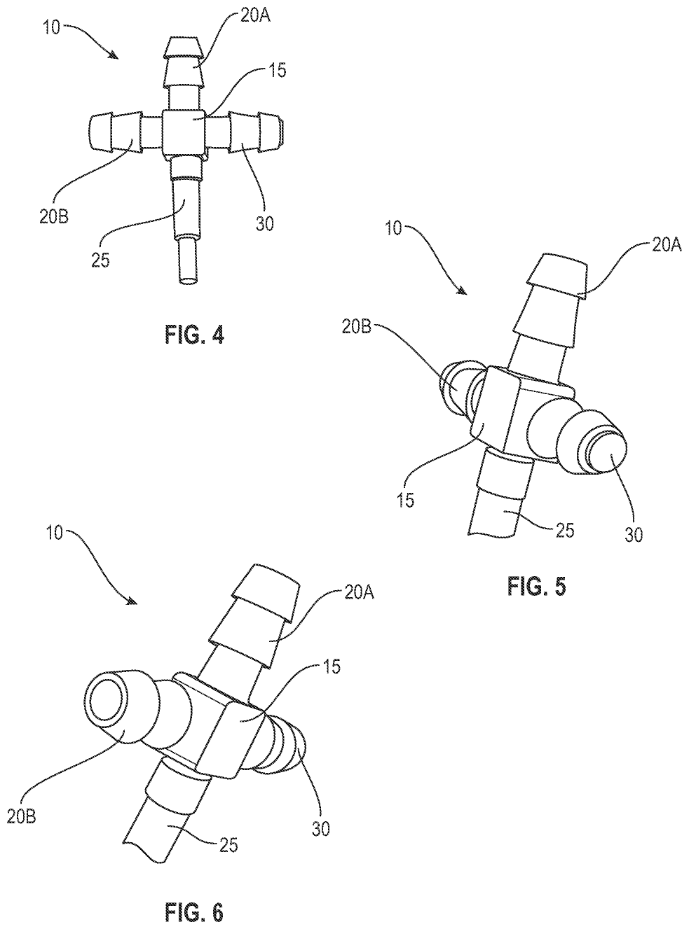

Referring first to FIG. 4, as well as FIGS. 5-8, a dead-end sap line connector, generally referred to using the reference numeral 10, will be described. The dead-end sap line connector 10 comprises a fluid transfer body 15 having interconnected walls defining a hollow inner chamber (not shown) being in fluid communication with a plurality of fittings each extending from one of said walls. A first fitting 20A of said plurality of fittings is engageable with the drop line to convey sap from the end tree to said inner chamber. A second fitting 20B of said plurality of fittings extends in a direction orthogonal to the first fitting 20A and is engageable with the lateral line of the sap collection system to convey sap from said inner chamber to the lateral line. The dead-end sap line connector 10 further comprises a sealing member 25 extending from one of said walls in a direction opposite to said first fitting 20A, said sealing member 25 having a sealing body to seal a corresponding spout or drop line adapted to receive sap from the end tree. In preferred embodiments, the first and second fittings 20A 20B are the only fittings of the dead-end sap line connector 10 that allow for sap flow (i.e. they are the only open fittings).

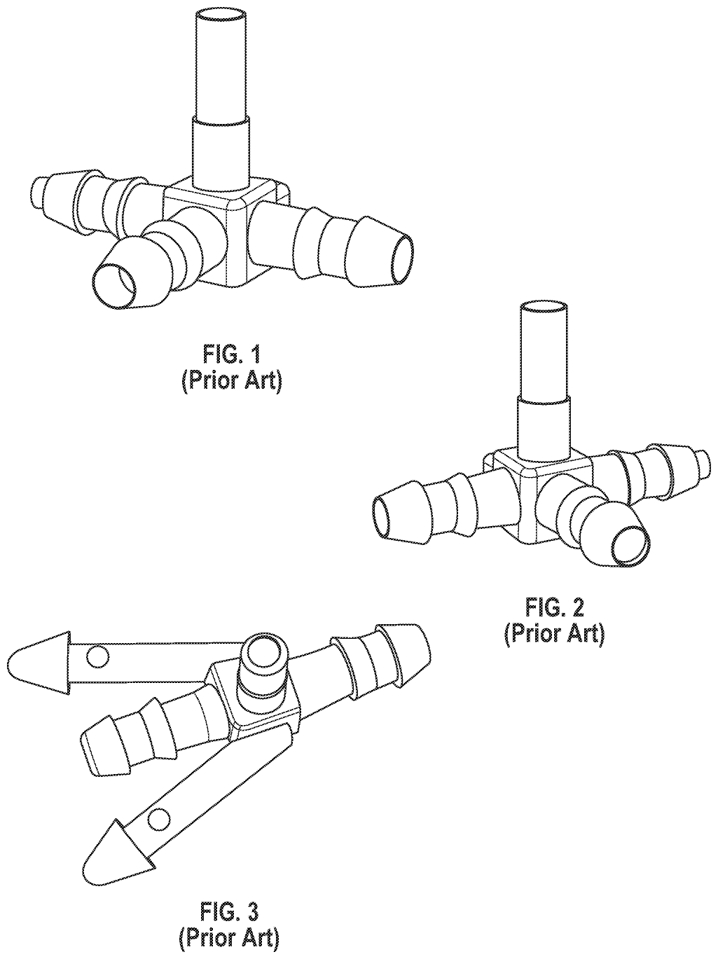

Because the sealing member 25 extends in a direction opposite to said first fitting 20A (as opposed to orthogonally to the plurality of fittings, as is the case for conventional dead-end sap line connectors), the dead-end sap line connector 10 of the present invention can be used to direct sap to the left or to the right without the need for more than one kind of dead-end sap line connector (e.g. without the need for both a conventional left-facing dead-end sap line connector and a conventional right-facing dead end sap line connector as shown in FIGS. 1-2); without rendering the sealing member inaccessible to the user (as it will always face downward regardless of how it is oriented, unlike conventional dead-end sap line connectors, where the sealing member would project towards the tree and become difficult to access if the dead-end sap line connector were to be rotated 180 degrees); and without creating unnecessary bends and turns in the lateral line or the drop line (unlike conventional Y-shaped dead-end sap line connectors, where directing the sap towards the left or the right would require bending the lateral line or the drop line, which can stress and strain the lateral line or the drop line and cause plugs therein if bent too severely).

The dead-end sap line connector 10 further comprises a plugged fitting 30 extending from one of said walls in a direction opposite to said second fitting 20B and being engageable with end-tree tubing adapted to secure said dead-end sap line connector 10 to the end tree. As the plugged fitting 30 is plugged, it does not allow sap to travel through it, thereby preventing sap from getting trapped. As this fitting is plugged, sap can only travel from the drop line to the lateral line. In preferred embodiments, the plugged fitting 30 is the only fitting of the dead-end sap line connector 10 that is plugged (i.e. there is only a single plugged fitting).

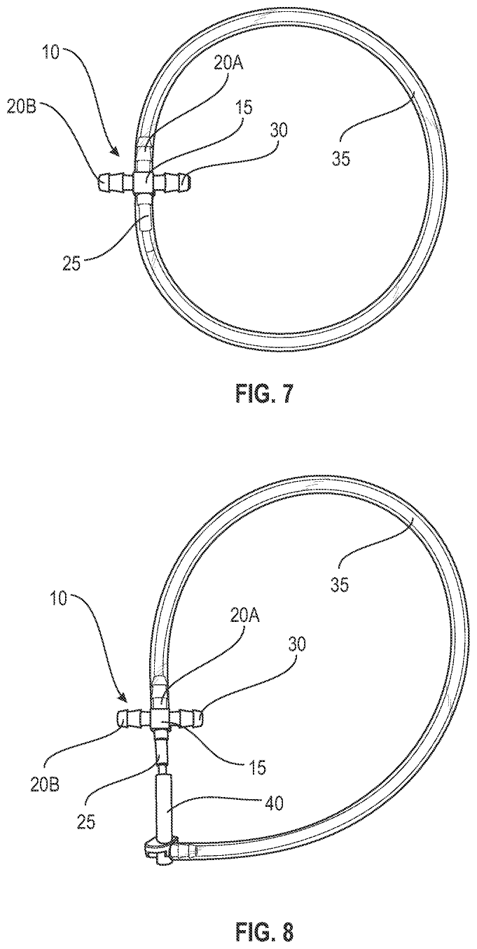

In embodiments, the fittings are shaped and configured to releasably yet securely engage with tubing commonly used for drop lines and lateral lines, such as 5/16″ tubing or 3/16″ tubing, preferably 5/16″ tubing. In FIGS. 7 and 8, the drop line 35 is releasably yet securely engaged with the first fitting 20A.

In preferred embodiments, and as shown for example in FIGS. 4-6, each of the fittings comprises barbs in order to more securely engage the tubing of the lateral line, the drop line, or the end-tree tubing.

As mentioned, the sealing member 25 is a plug, pin (such as a 2-stage pin or a 3-stage pin), or cap, which can be used to seal a corresponding tap or spout (or the drop line directly in the case of producers that toss their spouts after the gathering season). In preferred embodiments, and as shown for example in FIG. 4, the sealing member 25 is a 3-stage pin that can be used to seal either a tap or spout 40 (as shown in FIG. 8) or drop line 35 (as shown in FIG. 7), depending on the user's needs. The skilled person would understand that the pin shown in FIG. 4 is merely an example, and that other pin designs (such as a 2-stage pin) are possible.

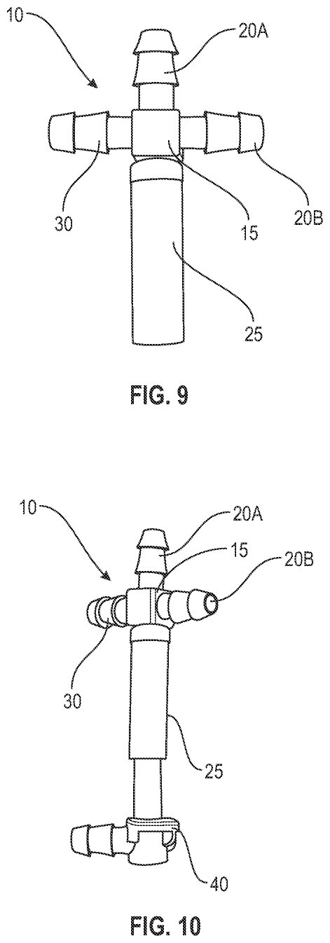

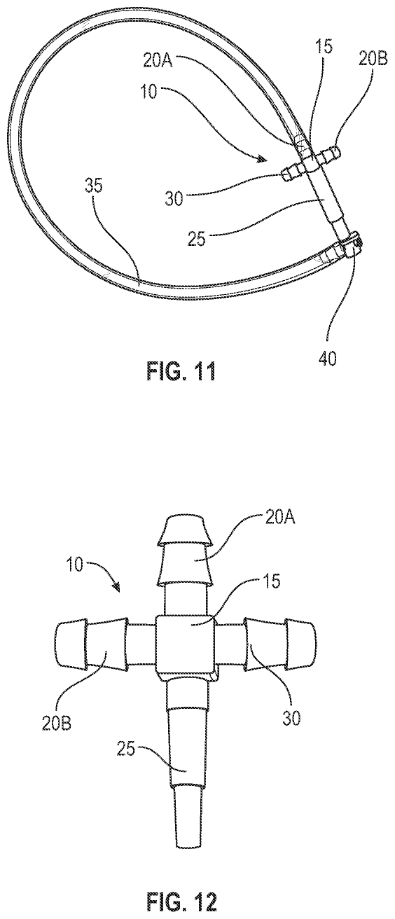

Alternatively, and as shown for example in FIGS. 9-11, the sealing member 25 can be a cap that can sealingly and releasably receive a tap or spout 40. The skilled person would understand that the cap shown in FIGS. 9-11 is merely an example, and that other cap designs (such as caps with different lengths) are possible.

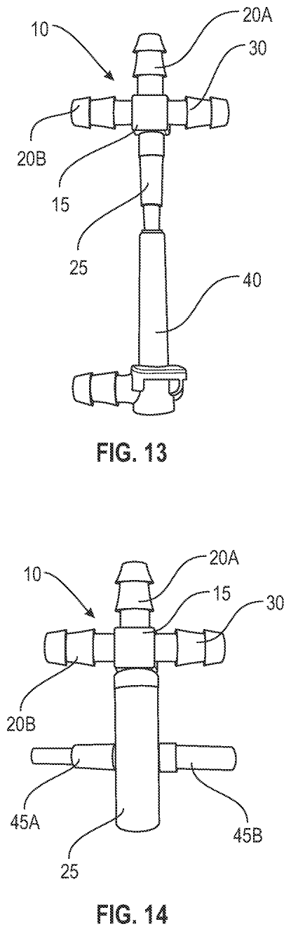

FIGS. 12 and 13 show an embodiment of the dead-end sap line connector 10 similar to that of FIGS. 4-8, except the dead-end sap line connector 10 is black instead of red. The skilled person would understand that any colour dead-end sap line connector 10 may be used, depending on the preference of the user.

In embodiments, and as shown for example in FIG. 14, the sealing member 25 may further comprise additional sealing members 45A 45B projecting out therefrom (for example, in directions parallel to the second fitting 20B and the plugged fitting 30 of the dead-end sap line connector 10). Such additional sealing members 45A 45B give more options for sealing the drop line or the spout. The skilled person would understand that such additional sealing members 45A 45B should only be added if they will not prevent use of the sealing member 25. For example, additional sealing members 45A 45B may prevent proper use of a 3-stage pin. In preferred embodiments, additional sealing members 45A 45B are not present, meaning sealing member 25 is the only sealing member.

As mentioned previously, the plugged fitting 30 is meant to releasably engage with end-tree tubing adapted to secure said dead-end sap line connector 10 to the end tree. The other end of the end-tree tubing can be secured using any means known in the art. The skilled person would understand that the dead-end sap line connector 10 does not need to be touching the end tree in order to be secured thereto (and in fact the dead-end sap line connector 10 is usually not placed in direct physical contact with the end tree). In embodiments, the other end of the end-tree tubing is secured using a line end hook or an end-ring fitting (not shown), which can allow the lateral line in question to be tightened or taken down easily for maintenance. Specifically, end-tree tubing can be wrapped around the back of the maple tree and then connected to the plugged fitting 30 and the line end hook or end-ring fitting, thereby creating a harness to support the dead-end sap line connector 10.

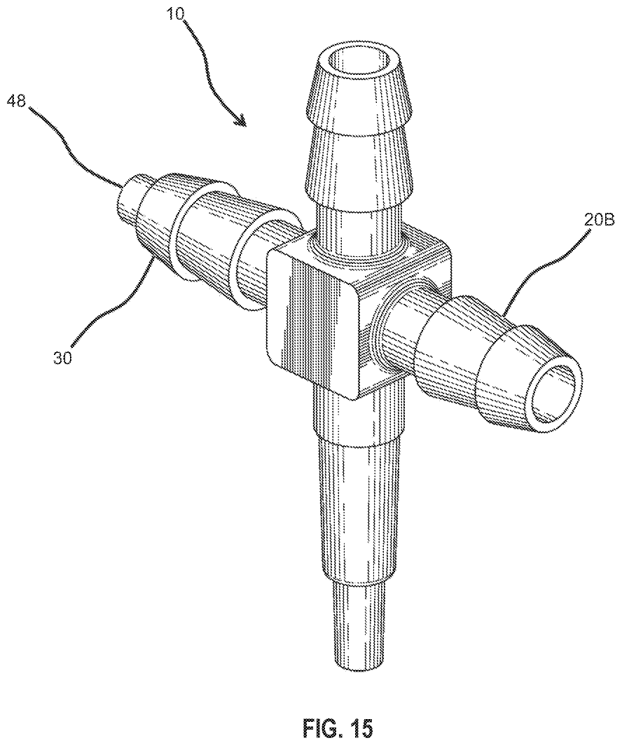

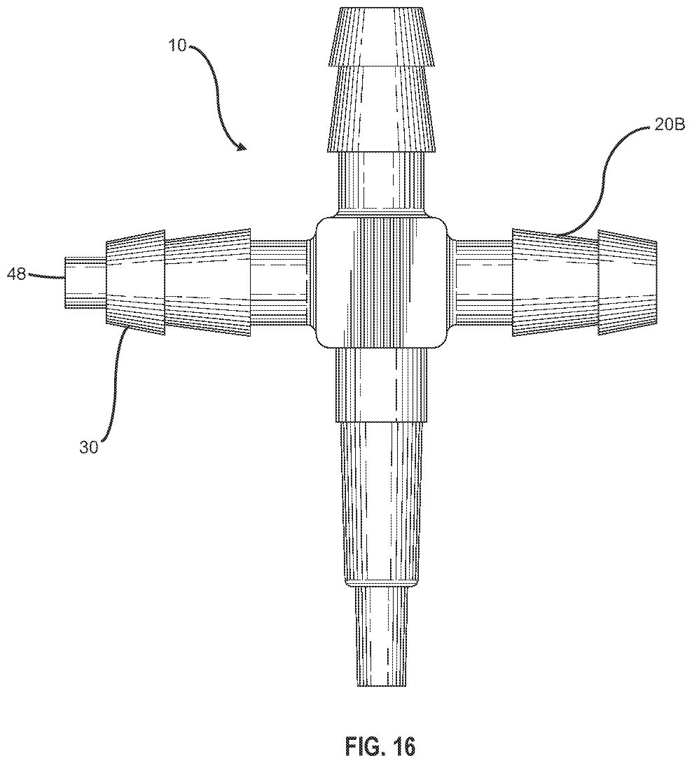

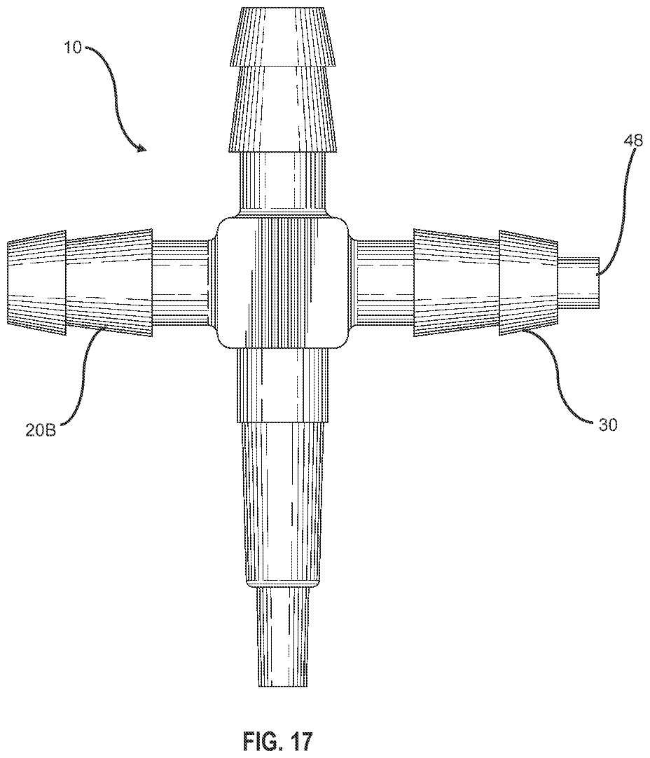

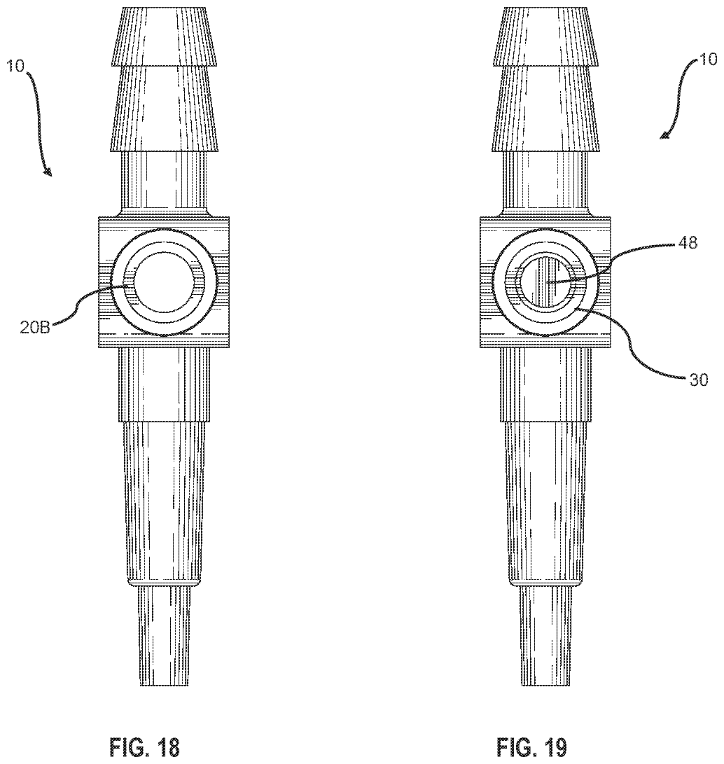

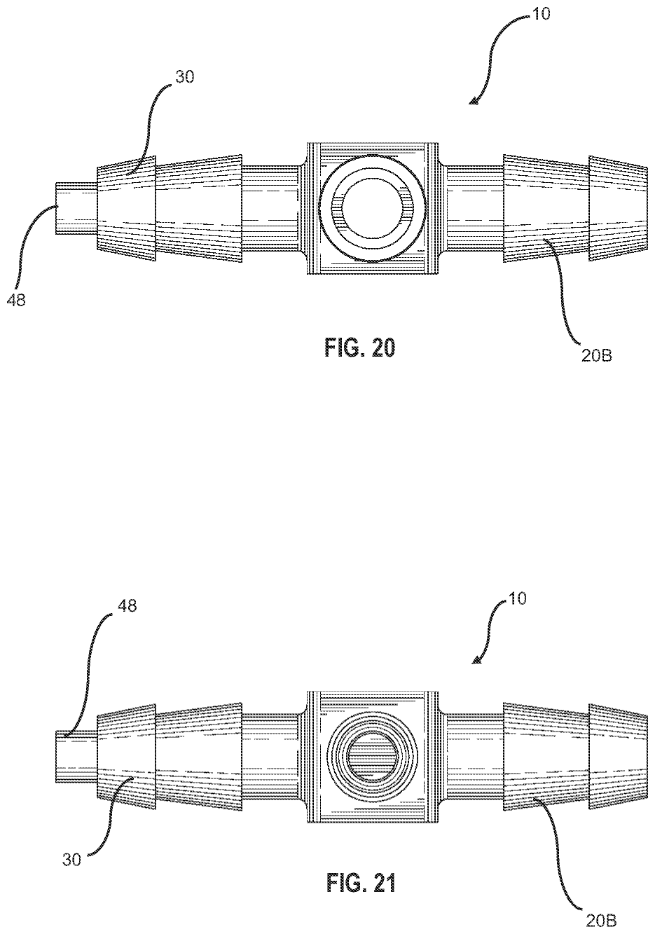

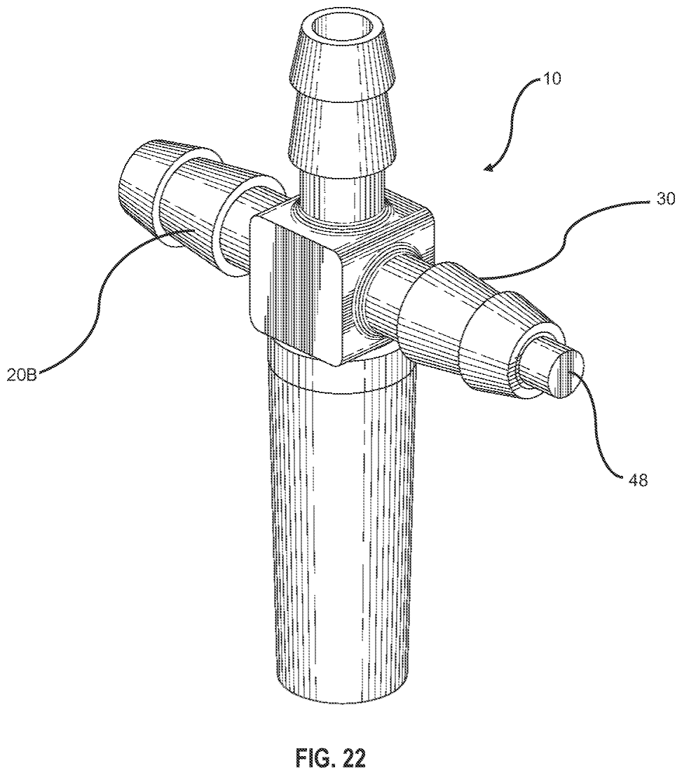

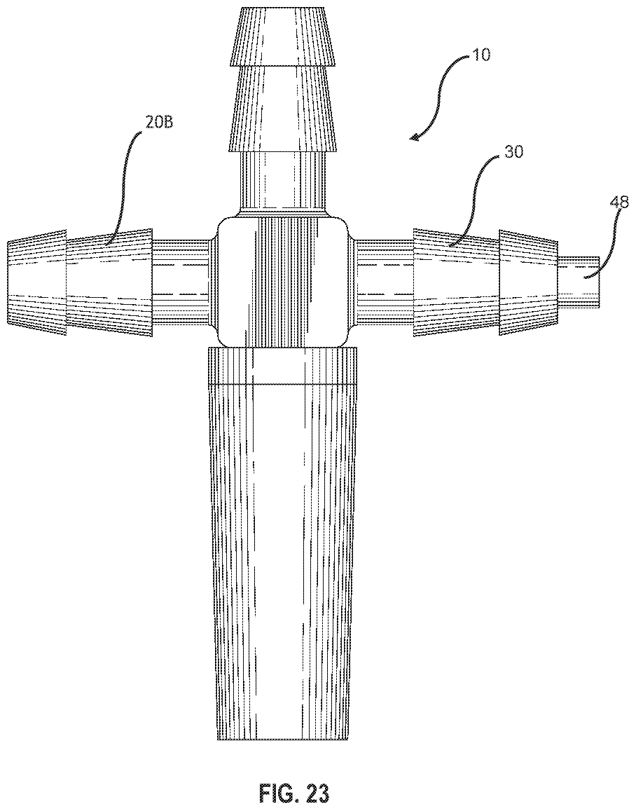

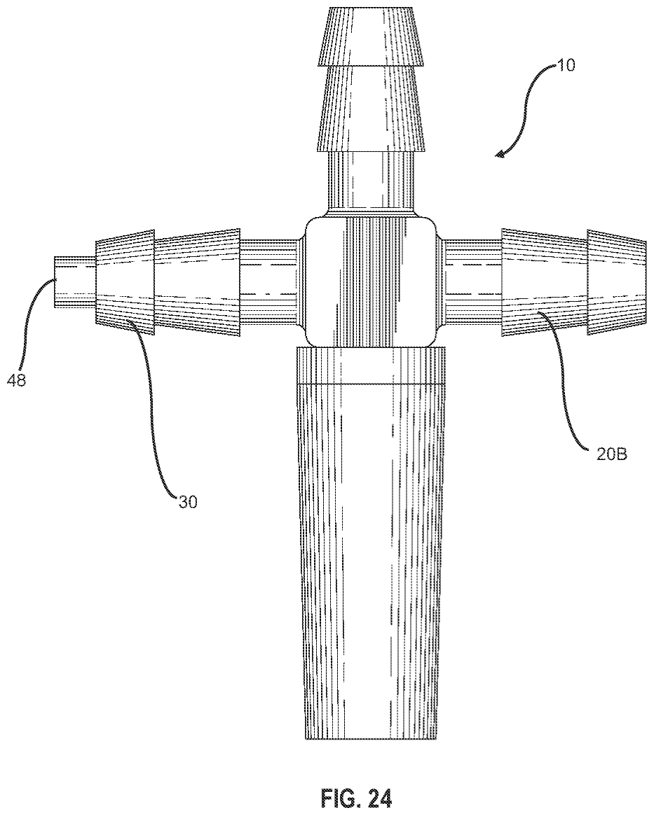

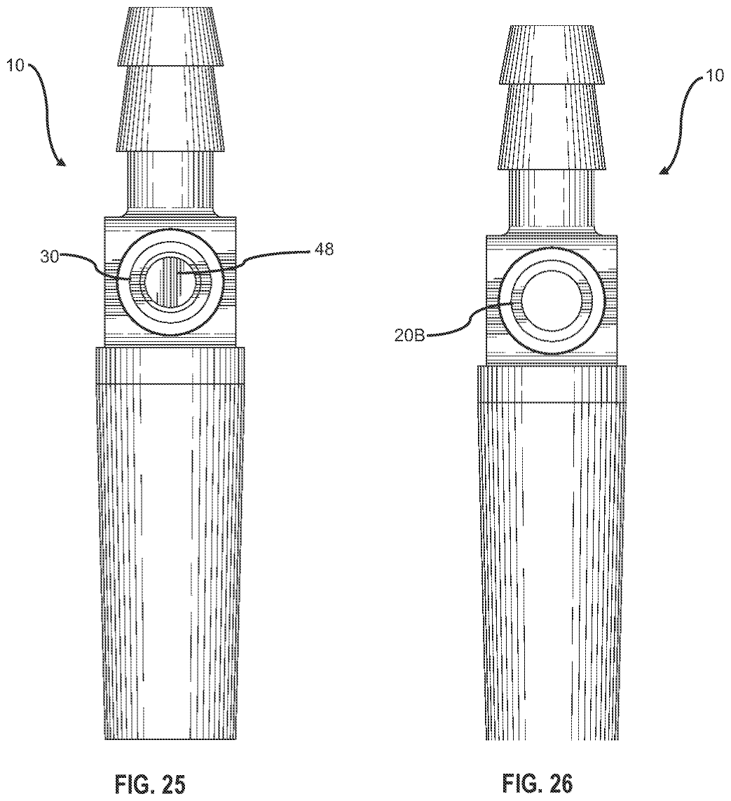

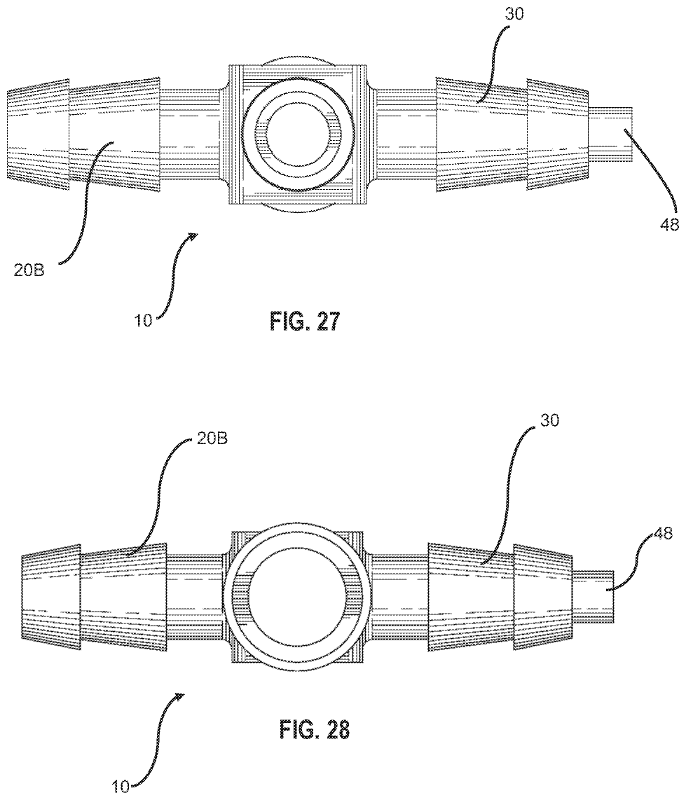

In preferred embodiments, the plugged fitting 30 can be visually distinct (e.g. by having a slightly different shape) from the second fitting 20B in order to make them more easily distinguishable from each other (thereby making it easier for a user to determine which of the fittings is the plugged fitting 30 and which is the second fitting 20B, even when viewing the dead-end sap line connector directly from the front or the back). For example, and in more preferred embodiments, the plugged fitting 30 can have a slight protrusion 48 on the end thereof (as shown in FIGS. 15-21 and FIGS. 22-28). For clarity, the dead-end sap line connectors of FIGS. 15-21 and FIGS. 22-28 are the same as those in FIGS. 12 and 9, respectively, except they comprise said slight protrusion 48 on the end of the plugged fitting 30 so as to better distinguish it from the second fitting 20B. As can be seen in FIGS. 15-21 and FIGS. 22-28, the presence of the protrusion 48 makes is easier to determine which of the fittings is the plugged fitting 30 and which is the second fitting 20B, even when viewing the dead-end sap line connector directly from the front or the back, as shown in FIGS. 16 and 17 and FIGS. 23 and 24. Conversely, without the slight protrusion 48, it would be more difficult to tell which of the fittings is the plugged fitting 30 and which is the second fitting 20B, especially when viewing the dead-end sap line connector directly from the front or the back. The skilled person would understand that, regardless of how the plugged fitting 30 and the second fitting 20B are made visually distinct from each other, such visual distinctiveness should not negatively affect the fittings' ability to connect to tubing or to allow sap to flow through (in the case of the second fitting 20B, which is not plugged).

The skilled person would understand that the dead-end sap line connector 10 of the present invention can be made of any plastic known in the art of making dead-end sap line connectors for sap collection systems (e.g. nylon). In preferred embodiments, the dead-end sap line connector 10 is made of nylon.

In embodiments, in addition to the advantages previously discussed, the dead-end sap line connector of the present invention may present one or more of the following advantages:

With the dead-end sap line connector of the present invention, instead of extending in a direction that is orthogonal to the other three fittings, the sealing member extends in a direction opposite to the first fitting where the drop line is connected to the sap line connector (thereby forming a dead-end sap line connector with a “cross” shape). With this arrangement, only one type of dead-end sap line connector needs to be used (regardless of whether sap will be flowing to the left or to the right). The dead-end sap line connector of the present invention need only be rotated 180 degrees such that the plugged fitting 30 is facing the appropriate direction. As a comparison, if a conventional dead-end sap line connector were to be rotated 180 degrees, the sealing member would extend inwardly towards the tree, making it much more difficult to access. With the dead-end sap line connector of the present invention, regardless of whether the plugged fitting 30 is oriented to face the “left” or the “right”, the sealing member will always be easily accessible.

In embodiments (such as those where the first and second fittings 20A 20B are the only open fittings, plugged fitting 30 is the only plugged fitting, and sealing member 25 is the only sealing member, as shown for example in FIG. 4), the dead-end sap line connector of the present invention offers the above-defined versatility (i.e. the ability to direct sap to the left or to the right without unnecessarily bending the lateral line and without the need for a “left” sap line connector and a “right” sap line connector) while also using a minimal amount of plastic and being easier to manufacture, thereby saving on raw materials and manufacturing costs.

As mentioned, the sealing member of the present invention can itself also include additional sealing members extending therefrom (for example, in directions parallel to the second fitting and the plugged fitting of the dead-end sap line connector). Such additional sealing members give more options for sealing the drop line or the spout, although they do require more plastic to make.

Sap Collection System Comprising Dead-End Sap Line Connector

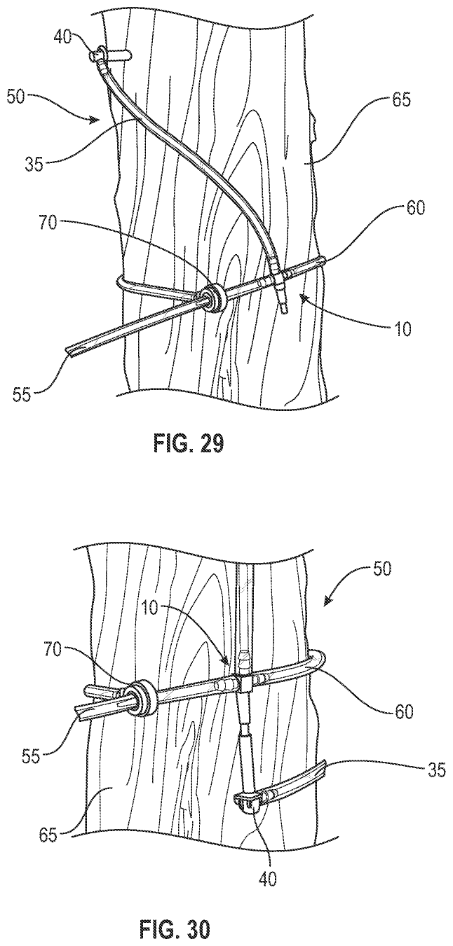

In a second aspect of the present invention, a sap collection system comprising the above-defined dead-end sap line connector 10 is provided. Referring first to FIGS. 29 and 30, said sap collection system, generally referred to using the reference numeral 50, will be described. Aside from the presence of the dead-end sap line connector 10, the sap collection system can be any sap collection system generally known in the art.

In embodiments, and as shown for example in FIGS. 29 and 30, the sap collection system 50 of the present invention comprises at least one lateral line 55, one or more drop lines 35, a tap or spout 40 for each drop line 35, end-tree tubing 60, and an end tree 65, wherein the drop line 35 of the end tree 65 is connected to the dead-end sap line connector 10 defined in the previous section, such that one or more lateral lines 55 are secured to their corresponding end tree 65 using the dead-end sap line connector 10.

In FIG. 29, the spout 40 is inserted into the end tree 65. However, as shown in FIG. 30, when not inserted into the end tree 65, the dead-end sap line connector 10 can be used to plug the spout 40 (or the drop line 35 directly), for example at the end of the season.

In the embodiments shown in FIGS. 29 and 30, the dead-end sap line connector 10 is being used to direct sap to the “left” of the end tree 65. However, for any end trees where the sap needs to be directed to the “right”, the dead-end sap line connector 10 need only be flipped 180 degrees, without the need for a different connector and without unnecessarily bending the lateral line 55.

In embodiments, the at least one lateral line 55 connects to a main line (not shown). The main line then brings the sap to a releaser and vacuum pump.

The at least one lateral line 55, the one or more drop lines 35, each tap or spout 40, and the end tree 65 can be conventional versions thereof, and can be as defined in the previous section. In general, sap collection systems comprise multiple lateral lines, each lateral line collecting sap from multiple trees using multiple drop lines and taps or spouts. Each lateral line will also comprise an end tree that terminates the lateral line (usually in an uphill direction from where the lateral line connects to the main line). In embodiments, each of the multiple lateral lines are secured to their corresponding end tree using the dead-end sap line connector 10.

As mentioned, the dead-end sap line connector 10 can be secured to the end tree 65 using a line end hook 70 or an end-ring fitting (not shown), which can allow the lateral line to be tightened or taken down easily for maintenance.

The skilled person would understand that the dead-end sap line connector 10 of the present invention can be used with any sap collection system comprising at least one end tree.

Alternative Dead-End Sap Line Connector

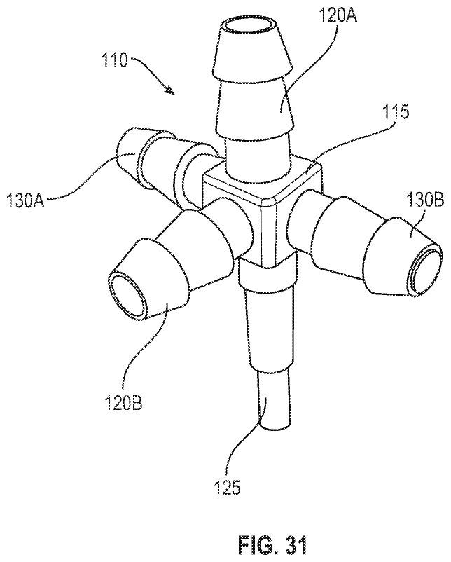

In a third aspect of the present invention, an additional, alternative dead-end sap line connector is provided. Referring first to FIG. 31, said alternative dead-end sap line connector, generally referred to using the reference numeral 110, will be described. The alternative dead-end sap line connector 110 comprises a fluid transfer body 115 having interconnected walls defining a hollow inner chamber (not shown) being in fluid communication with a plurality of fittings each extending from one of said walls. A first fitting 120A of said plurality of fittings is engageable with the drop line to convey sap from the end tree to said inner chamber. A second fitting 120B of said plurality of fittings extends in a direction orthogonal to the first fitting 120A and is engageable with the lateral line of the sap collection system to convey sap from said inner chamber to the lateral line. The dead-end sap line connector 110 further comprises a sealing member 125 extending from one of said walls in a direction opposite to said first fitting 120A, said sealing member 125 having a sealing body to seal a corresponding spout or drop line adapted to receive sap from the end tree. In preferred embodiments, the first and second fittings 120A 120B are the only fittings of the dead-end sap line connector 110 that allow for sap flow (i.e. they are the only fittings that are “open” and not plugged).

As shown in FIG. 31, the alternative dead-end sap line connector 110 further comprises two plugged fittings 130A 130B each extending from one of said walls. The first plugged fitting 130A extends in a direction orthogonal to the first and second fittings 120A 120B and the second plugged fitting 130B extends in a direction opposite to said first plugged fitting 130A. The plugged fittings 130A 130B are each engageable with end-tree tubing adapted to secure said dead-end sap line connector 110 to the end tree. As the plugged fittings 130A 130B are plugged, they do not allow sap to travel through them, thereby preventing sap from getting trapped. As these fittings are plugged, sap can only travel from the drop line to the lateral line. A length of tubing can be wrapped around the back of the maple tree and then connected to the two plugged fittings 130A 130B, thereby creating a harness to support the dead-end sap line connector 110. Because of the presence of the two plugged fittings 130A 130B, neither a line end hook nor an end-ring fitting is needed to create said hardness. In preferred embodiments, the two plugged fittings 130A 130B are the only fittings of the dead-end sap line connector 110 that are plugged (i.e. there are only two plugged fittings).

In embodiments, the fittings are shaped and configured to releasably yet securely engage with tubing commonly used for drop lines and lateral lines, such as 5/16″ tubing or 3/16″ tubing, preferably 5/16″ tubing.

In preferred embodiments, and as shown for example in FIG. 31, each of the fittings comprises barbs in order to more securely engage the tubing of the lateral line, the drop line, or the end-tree tubing.

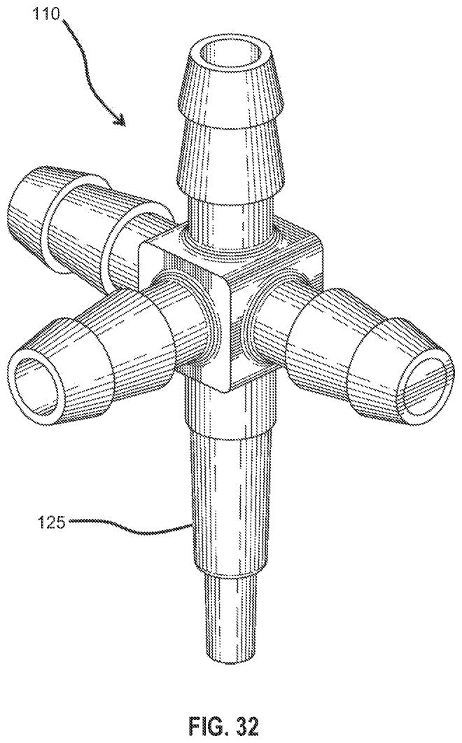

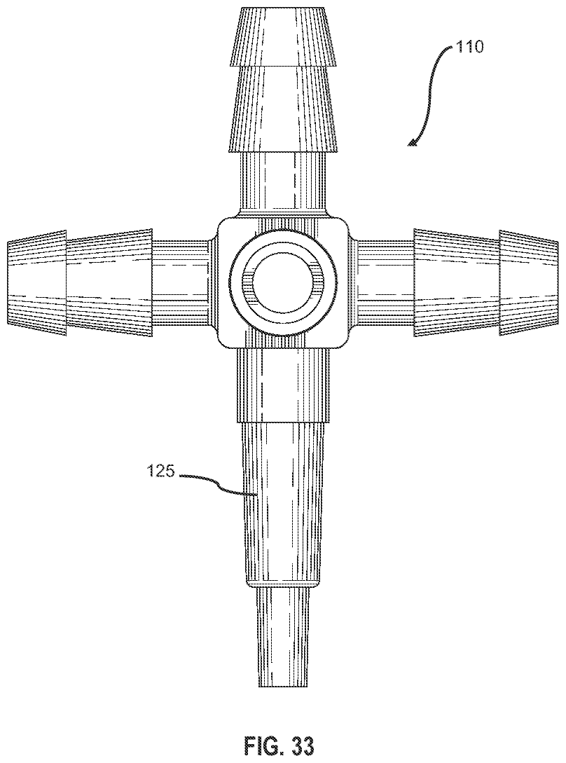

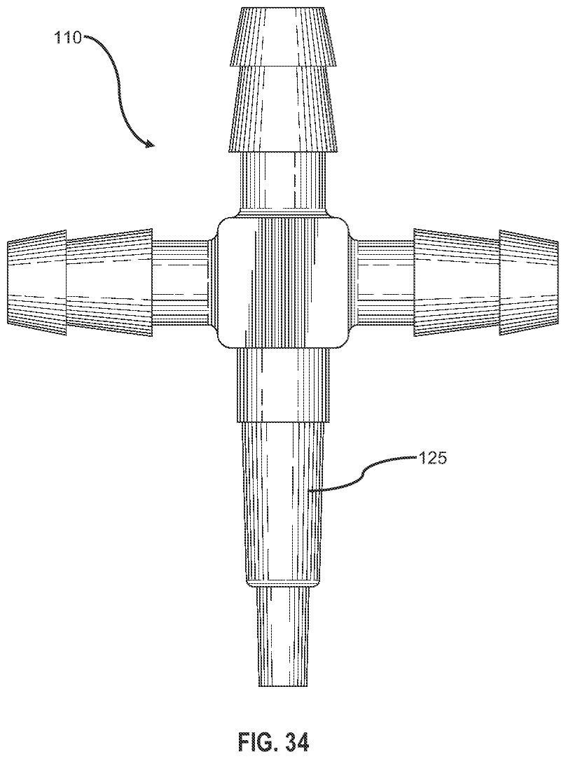

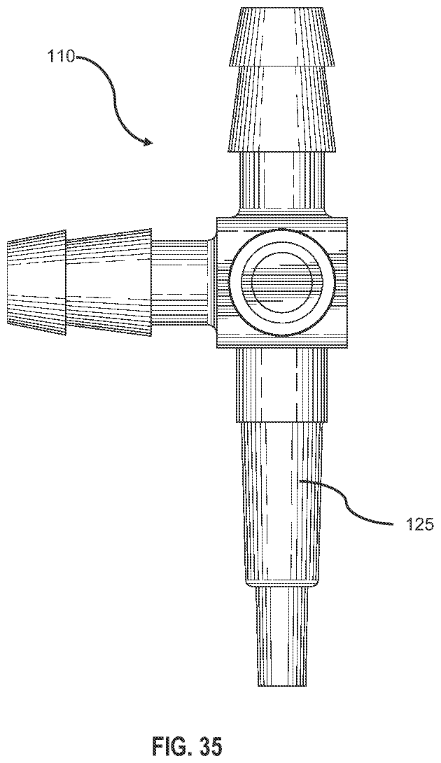

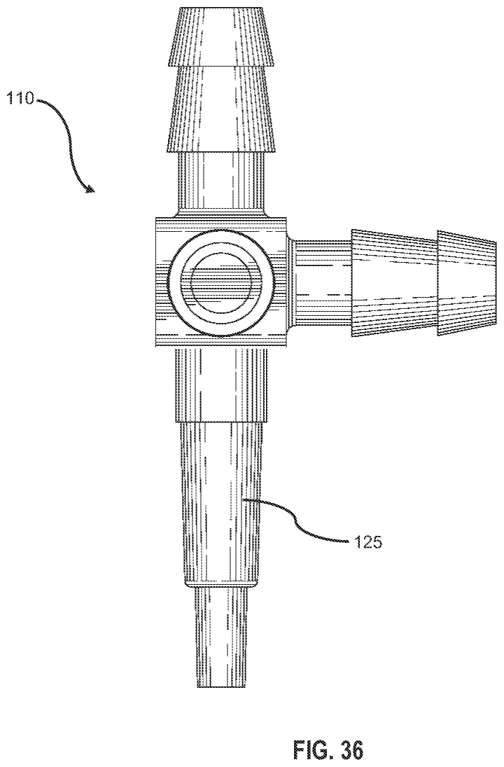

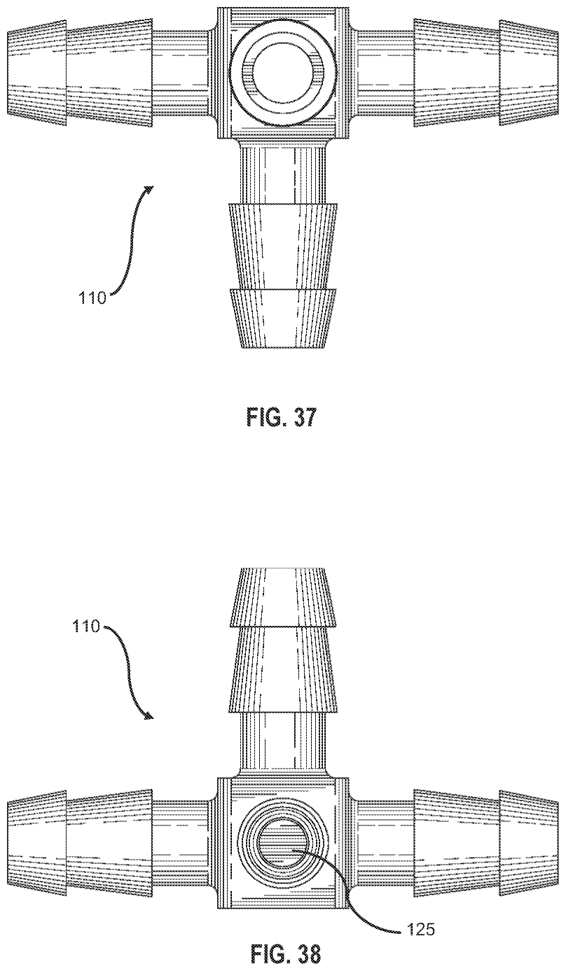

FIGS. 32-38 shows multiple views of the alternative dead-end sap line connector shown in FIG. 31.

The sealing member 125 is a plug, pin (such as a 2-stage pin or a 3-stage pin), or cap, which can be used to seal a corresponding tap or spout (or the drop line directly in the case of producers that toss their spouts after the gathering season). In preferred embodiments, and as shown for example in FIG. 31 and FIGS. 32-38, the sealing member 125 can be a 3-stage pin that can be used to seal either a tap or spout or drop line, depending on the user's needs. The skilled person would understand that the pin shown in FIG. 31 and FIGS. 32-38 is merely an example, and that other pin designs (such as a 2-stage pin) are possible.

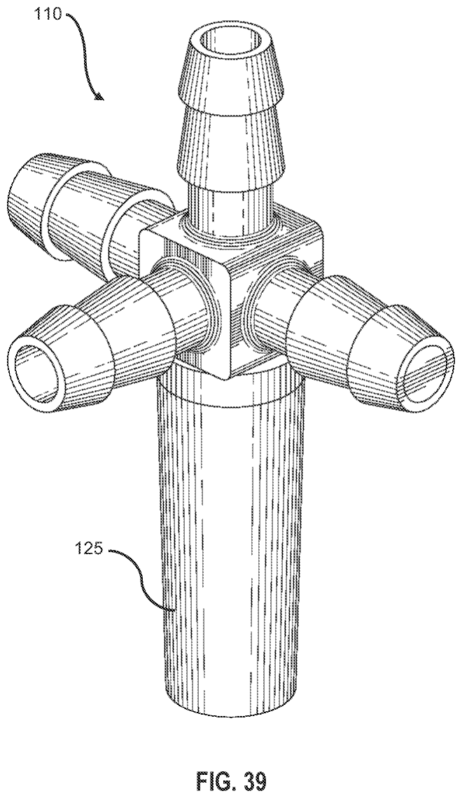

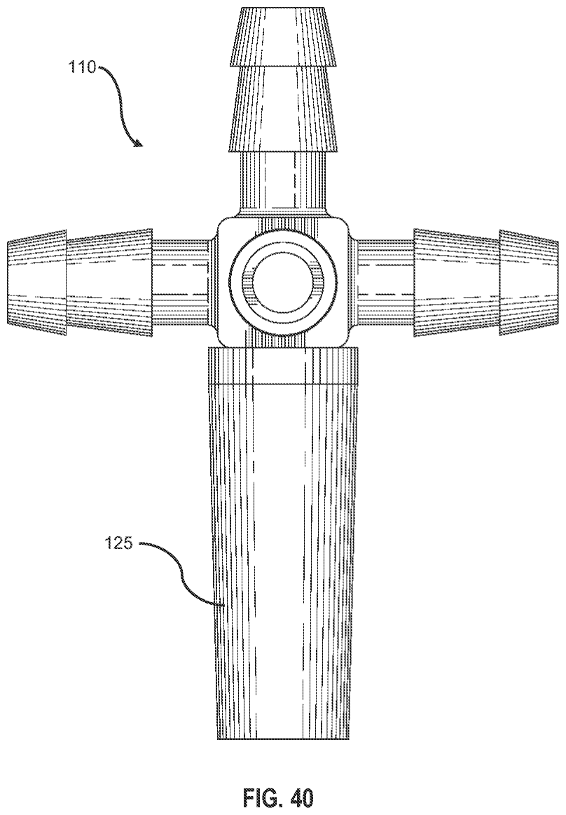

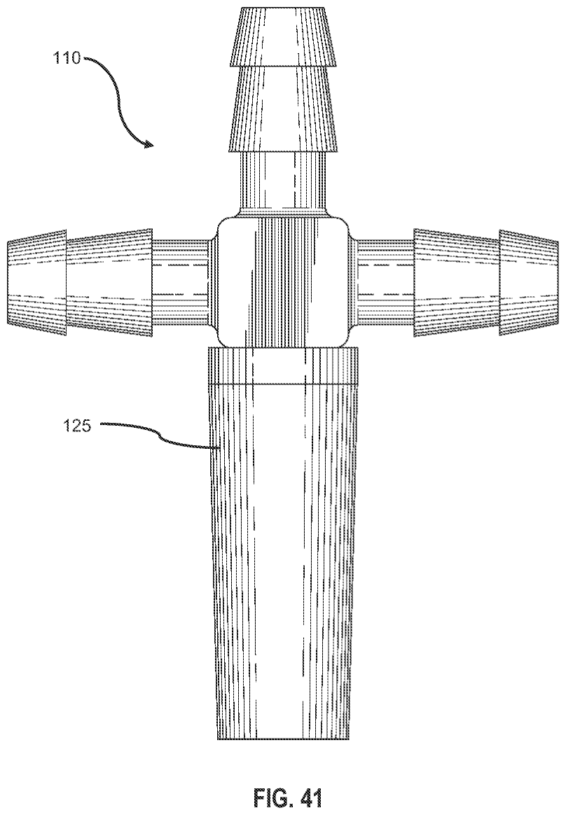

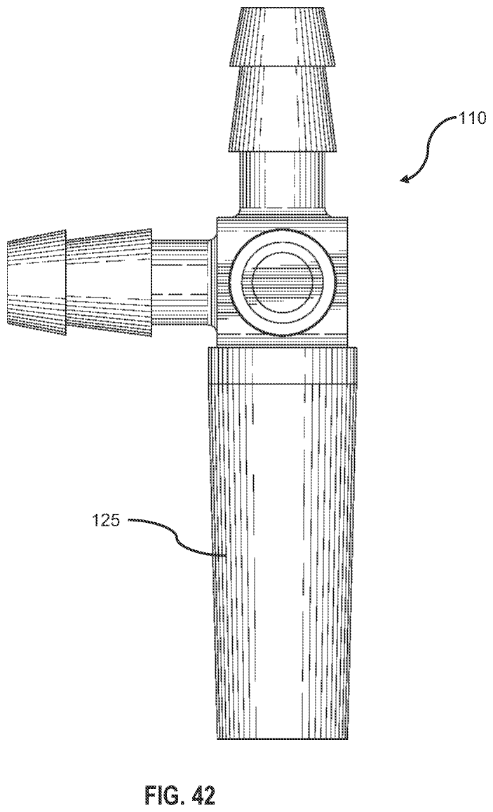

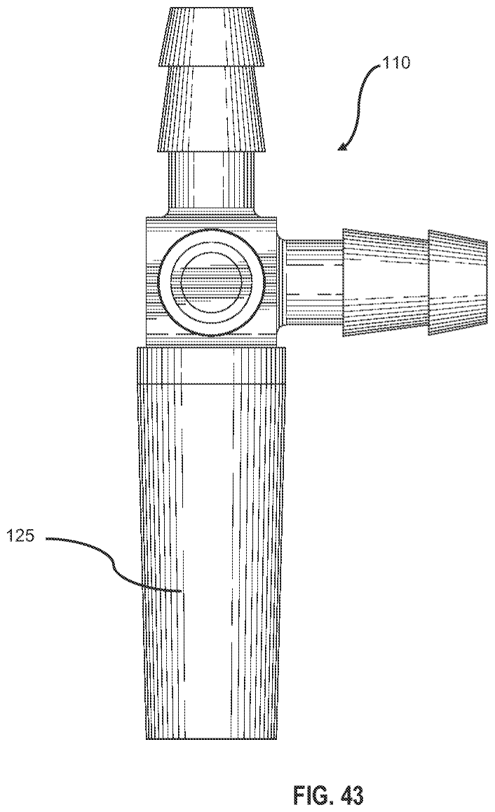

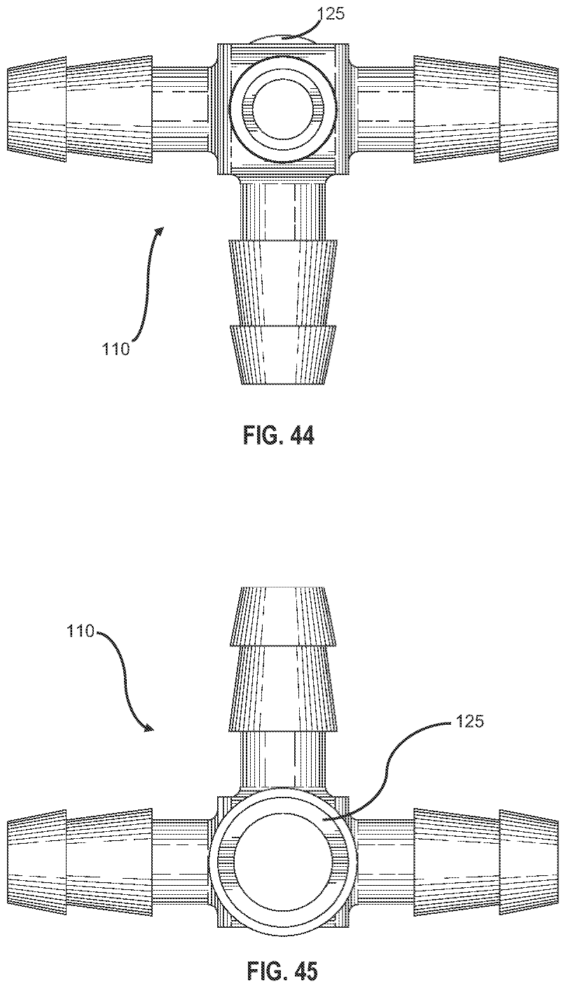

Alternatively, and as shown for example in FIGS. 39-45, the sealing member 125 can be a cap that can sealingly and releasably receive a tap or spout. The skilled person would understand that the cap shown in FIGS. 39-45 is merely an example, and that other cap designs (such as caps with different lengths) are possible.

The skilled person would understand that any colour alternative dead-end sap line connector 110 may be used, depending on the preference of the user.

The skilled person would understand that the alternative dead-end sap line connector 110 of the present invention can be made of any plastic known in the art of making dead-end sap line connectors for sap collection systems (e.g. nylon). In preferred embodiments, the alternative dead-end sap line connector 110 is made of nylon.

In embodiments, the sealing member 125 may further comprise additional sealing members (not shown) projecting out therefrom (for example, in directions parallel to the plugged fittings 130A 1308 of the dead-end sap line connector 110). Such additional sealing members give more options for sealing the drop line or the spout. The skilled person would understand that such additional sealing members should only be added if they will not prevent use of the sealing member 125. For example, additional sealing members may prevent proper use of a 3-stage pin. In preferred embodiments, additional sealing members are not present, meaning sealing member 125 is the only sealing member.

With conventional Y-shaped dead-end connectors (shown in FIG. 3), conventional tubing tools are difficult to use for the two plugged fittings forming the “Y” portion of the connector. This is because typical tubing tools (both one-handed and two-handed) are easiest to use when the fitting in question projects perpendicularly from the connector, providing either a flat surface that is orthogonal to the fitting or an opposingly-directioned fitting with which the tubing tool can engage.

One-handed tubing tools can be used to connect tubing to the fitting of a connector by engaging the tubing and the connector. However, one-handed tubing tools typically connect the tubing to the connector by applying pressure to the connector in question. If such a tubing tool were to be used on a Y-shaped dead-end sap line connector (specifically one of the plugged fittings forming the “Y” branches), the tubing tool may apply pressure on other fittings at an angle, which may damage or weaken said fittings, especially after repeated use. Furthermore, as the surface opposite the plugged fittings forming the “Y” branches is not orthogonal to the direction of the plugged fitting, the flat surface of the one-handed tubing tool will apply uneven pressure to the Y-shaped dead-end sap line connector, which could potentially weaken or damage said sap line connector.

With this embodiment of the dead-end sap line connector 110 of the present invention, this problem is avoided, because all of the fittings project orthogonally from the surface of the connector.

Similarly, two-handed tubing tools typically connect tubing to fittings by gripping two segments of tubing and squeezing them together. However, with Y-shaped dead-end sap line connectors, when attaching tubing to one of the Y branches, it is difficult to grip two segments of tubing because there is no fitting projecting in an opposite direction to the Y branch.

With this embodiment of the dead-end sap line connector 110 of the present invention, this problem is avoided, because all of the fittings project orthogonally from the surface of the connector, and the two plugged fittings 130A 130B extend in opposite directions.

Accordingly, with this embodiment of the dead-end sap line connector 110 of the present invention, each fitting either has a corresponding fitting projecting in an opposite direction (thereby facilitating use of a two-handed tubing tool), or a corresponding flat surface on which to use a one-handed tubing tool without applying undue stress on other fittings and the dead-end sap line connector 110 itself.

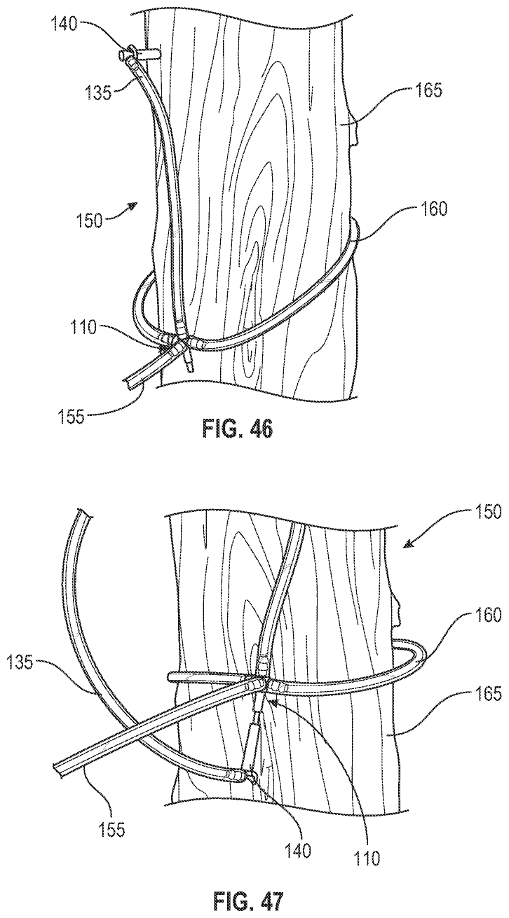

This dead-end sap line connector 110 can be used in sap collection systems, such as the one defined in the previous section, and for example as shown in FIGS. 46-47. In embodiments, and as shown for example in FIGS. 46 and 47, this sap collection system 150 comprises at least one lateral line 155, one or more drop lines 135, a tap or spout 140 for each drop line 135, end-tree tubing 160, and an end tree 165, wherein the drop line 135 of the end tree 165 is connected to the dead-end sap line connector 110, such that one or more lateral lines 155 are secured to their corresponding end tree 165 using the dead-end sap line connector 110.

In FIG. 46, the spout 140 is inserted into the end tree 165. However, as shown in FIG. 47, when not inserted into the end tree 165, the dead-end sap line connector 110 can be used to plug the spout 140 (or the drop line 135 directly), for example at the end of the season.

In embodiments, the at least one lateral line 155 connects to a main line (not shown). The main line then brings the sap to a releaser and vacuum pump.

The scope of the claims should not be limited by the preferred embodiments set forth in the examples, but should be given the broadest interpretation consistent with the description as a whole.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

1. A dead-end sap line connector for a sap collection system comprising a drop line, an end tree, end-tree tubing, and a lateral line, wherein the dead-end sap line connector comprises:
a fluid transfer body having interconnected walls defining a hollow inner chamber being in fluid communication with a plurality of fittings each extending from one of said walls; a first fitting of said plurality of fittings being engageable with the drop line to convey sap from the end tree to said inner chamber; and a second fitting of said plurality of fittings extending in a direction orthogonal to the first fitting and being engageable with the lateral line of the sap collection system to convey sap from said inner chamber to the lateral line;
a sealing member extending from one of said walls in a direction opposite to said first fitting, said sealing member having a sealing body to seal a corresponding spout or drop line adapted to receive sap from the end tree; and
a plugged fitting extending from one of said walls in a direction opposite to said second fitting and being engageable with end-tree tubing adapted to secure said dead-end sap line connector to the end tree.

2. The dead-end sap line connector of claim 1, wherein at least one of the first fitting, the second fitting, the sealing member, or the plugged fitting is shaped and configured to releasably yet securely engage with 5/16″ tubing or 3/16″ tubing.

3. The dead-end sap line connector of claim 1, wherein the first fitting, the second fitting, the sealing member, and the plugged fitting are each shaped and configured to releasably yet securely engage with 5/16″ tubing or 3/16″ tubing.

4. The dead-end sap line connector of claim 1, wherein each of the first fitting, the second fitting, the plugged fitting, and the sealing member comprises barbs.

5. The dead-end sap line connector of claim 1, wherein the sealing member is a plug, pin, or cap.

6. The dead-end sap line connector of claim 1, wherein the sealing member is a 3-stage pin configured to seal either a tap or spout or drop line.

7. The dead-end sap line connector of claim 1, wherein the sealing member is a cap configured to sealingly and releasably receive a tap or spout.

8. The dead-end sap line connector of claim 1, wherein the sealing member comprises additional sealing members projecting out therefrom.

9. The dead-end sap line connector of claim 8, wherein the additional sealing members project out from the sealing member in directions parallel to the second fitting and the plugged fitting.

10. The dead-end sap line connector of claim 1, wherein the plugged fitting is visually distinct from the second fitting.

11. The dead-end sap line connector of claim 1, wherein the plugged fitting has a slight protrusion on a distal end thereof.

12. A sap collection system comprising the dead-end sap line connector of claim 1.

13. The sap collection system of claim 12, wherein the sap collection system comprises at least one lateral line, one or more drop lines, a tap or spout for each drop line, end-tree tubing, and an end tree, wherein one or more lateral lines are secured to their corresponding end tree using the dead-end sap line connector as defined in claim 1.

14. The sap collection system of claim 13, wherein the at least one lateral line connects to a main line.

15. The sap collection system of claim 14, wherein the main line brings the sap to a releaser and vacuum pump.

16. The sap collection system of any one of claim 12, wherein the sap collection system comprises multiple lateral lines, wherein each lateral line is secured to its corresponding end tree using the dead-end sap line connector as defined in claim 1.

17. The sap collection system of claim 12, wherein the dead-end sap line connector is secured to a corresponding end tree using a line end hook or an end-ring fitting.

18. A dead-end sap line connector fora sap collection system comprising a drop line, an end tree, end-tree tubing, and a lateral line, wherein the dead-end sap line connector comprises:
a fluid transfer body having interconnected walls defining a hollow inner chamber being in fluid communication with a plurality of sap fittings each extending from one of said walls; a first fitting of said plurality of fittings being engageable with the drop line to convey sap from the end tree to said inner chamber; and a second fitting of said plurality of fittings extending in a direction orthogonal to the first fitting and being engageable with the lateral line of the sap collection system to convey sap from said inner chamber to the lateral line;
a sealing member extending from one of said walls in a direction opposite to said first fitting, said sealing member having a sealing body to seal a corresponding spout or drop line adapted to receive sap from the end tree; and
a first plugged fitting and a second plugged fitting, each extending from one of said walls in a direction orthogonal to said first fitting and said second fitting and being engageable with end-tree tubing adapted to secure said dead-end sap line connector to the end tree, said first plugged fitting extending in a direction opposite to said second plugged fitting.

19. A sap collection system comprising the dead-end sap line connector of claim 18.
